(19) United States
(12) Patent Application Publication
(10) Pub. No.: US 2026/0303416 A1
(43) Pub. Date: Oct. 1, 2026

(54) EQUALIZER CIRCUIT AND CALIBRATION METHOD THEREFOR

(71) Applicant: Novatek Microelectronics Corp., Hsinchu (TW)

(72) Inventors: Chih Cheng Lin, Hsinchu City (TW); Ka Wai Tang, Hsinchu City (TW); Yu An Yang, Hsinchu City (TW)

(73) Assignee: Novatek Microelectronics Corp., Hsinchu (TW)

(21) Appl. No.: 19/091,869

(22) Filed: Mar. 27, 2025

(51) Int. Cl. H04L 25/03; H04B 3/04

(52) U.S. Cl. CPC H04L 25/03057; H04B 3/04; H04L 25/03878

(57) ABSTRACT

An equalizer circuit including a first summing circuit, a second summing circuit, a first sampler circuit, a second sampler circuit, and a multiplexer is provided. The first sampler circuit generates a first sampled signal which is weighted to generate a second feedback signal. The second sampler circuit generates a second sampled signal which is weighted to generate a first feedback signal. The multiplexer generates a polarity indication signal based on one of the first sampled signal and the second sampled signal. The equalizer circuit performs a first calibration operation to compensate for a first offset voltage of the equalizer circuit based on a preset threshold voltage, and performs a second calibration operation to compensate for a second offset voltage of the equalizer circuit based on the weight value used for generating the first feedback signal, the weight value used for generating the second feedback signal, and the polarity indication signal.

### BACKGROUND

### Technical Field

The disclosure relates to an equalizer circuit, and more particularly, relates to an equalizer circuit and a calibration method therefor.

### Description of Related Art

Decision feedback equalizer (DFE) is commonly used in high-speed communication systems. In order to operate the DFE at a high-speed data rate, the feedback signals should be settled accurately at the input of the sampler circuits before the next data decision is made. However, the inter-symbol interference (ISI) may occur in the data channels when the DFE operates at a high-speed data rate. Conventionally, a half-rate DFE architecture usually requires more sampler circuits (i.e., four sampler circuits) to remove the inter-symbol interference (ISI) from the data stream in the odd channel and in the even channel. Therefore, conventional half-rate DFE consumes more power and occupies more chip area.

### SUMMARY

The disclosure provides an equalizer circuit and a calibration method, which can calibrate the equalizer circuit with reduced power consumption and reduced layout area.

In an embodiment of the disclosure, an equalizer circuit is provided. The equalizer circuit includes a first summing circuit, a second summing circuit, a first sampler circuit, a second sampler circuit, and a multiplexer. The first summing circuit is configured to generate a first summing signal based on an input signal, a first feedback signal, and a polarity indication signal. The polarity indication signal indicates a polarity of a weight value used for generating the first feedback signal. The second summing circuit is configured to generate a second summing signal based on the input signal, a second feedback signal, and the polarity indication signal. The polarity indication signal indicates a polarity of a weight value used for generating the second feedback signal. The first sampler circuit is coupled between an output terminal of the first summing circuit and an input terminal of the second summing circuit. The first sampler circuit is configured to generate a first sampled signal based on the first summing signal, and the first sampled signal is weighted to generate the second feedback signal. The second sampler circuit is coupled between an output terminal of the second summing circuit and an input terminal of the first summing circuit. The second sampler circuit is configured to generate a second sampled signal based on the second summing signal, and the second sampled signal is weighted to generate the first feedback signal. The multiplexer is coupled to an output terminal of the first sampler circuit and an output terminal of the second sampler circuit. The multiplexer is configured to generate the polarity indication signal based on one of the first sampled signal and the second sampled signal. The equalizer circuit is configured to perform a first calibration operation to compensate for a first offset voltage of the equalizer circuit based on a preset threshold voltage. The equalizer circuit is further configured to perform a second calibration operation to compensate for a second offset voltage of the equalizer circuit based on the weight value used for generating the first feedback signal, the weight value used for generating the second feedback signal, and the polarity indication signal.

In an embodiment of the disclosure, a calibration method for an equalizer circuit is provided. The equalizer circuit includes a first sampler circuit, a second sampler circuit, and a multiplexer. The first sampler circuit is configured to generate a first sampled signal, and the first sampled signal is weighted to generate the second feedback signal. The second sampler circuit is configured to generate a second sampled signal, and the second sampled signal is weighted to generate the first feedback signal. The multiplexer is coupled to an output terminal of the first sampler circuit and an output terminal of the second sampler circuit. The multiplexer is configured to generate a polarity indication signal based on one of the first sampled signal and the second sampled signal. The polarity indication signal indicates a polarity of a weight value used for generating the first feedback signal and a polarity of a weight value used for generating the second feedback signal. The calibration method for the equalizer circuit includes performing a first calibration operation to compensate for a first offset voltage of the equalizer circuit based on a preset threshold voltage; and performing a second calibration operation to compensate for a second offset voltage of the equalizer circuit based on the weight value used for generating the first feedback signal, the weight value used for generating the second feedback signal, and the polarity indication signal.

Based on the above, in the embodiments of the disclosure, the equalizer circuit uses a polarity indication signal to indicate a polarity of a weight value for each of the even channel and the odd channel. Accordingly, a calibration operation based on a weight value having positive polarity and a weight value having negative polarity can be performed using a single sampler circuit combined with a single summing circuit, which requires fewer sampler circuits and summing circuits to perform the calibration operation. In addition, the clock loading and the power consumption of the equalizer circuit can be highly decreased due to both reduced sampler circuits and reduced summing circuits in the equalizer circuit. Therefore, the equalizer circuit and the calibration method of the disclosure can realize a DFE architecture with low-power and high-speed operation.

In order to make the above-mentioned features and advantages of the disclosure comprehensible, embodiments accompanied with drawings are described in detail below.

### BRIEF DESCRIPTION OF THE DRAWINGS

FIG. 1 is a block diagram of an equalizer circuit according to an embodiment of the disclosure.

FIG. 2 is a flowchart of a calibration method according to an embodiment of the disclosure.

FIG. 3 depicts a detailed circuit to demonstrate a combined architecture of the first summing circuit and the first sampler circuit shown in FIG. 1 according to an embodiment of the disclosure.

### DESCRIPTION OF THE EMBODIMENTS

The term “coupled (or connected)” as used throughout this specification (including the scope of the application) may refer to any direct or indirect means of connection. For example, if it is described in the specification that a first device is coupled (or connected) to a second device, it should be construed that the first device can be directly connected to the second device, or the first device can be indirectly connected to the second device through another device or some type of connecting means. Terms “first,” “second” and the like mentioned in the full text (including the scope of the patent application) of the description of this application are used only to name the elements or to distinguish different embodiments or scopes and are not intended to limit the upper or lower limit of the number of the elements, nor is it intended to limit the order of the elements. In addition, wherever possible, elements/components/steps with the same reference numerals in the drawings and embodiments represent the same or similar parts. Elements/components/steps that use the same reference numerals or use the same terminology in different embodiments may refer to relevant descriptions of each other.

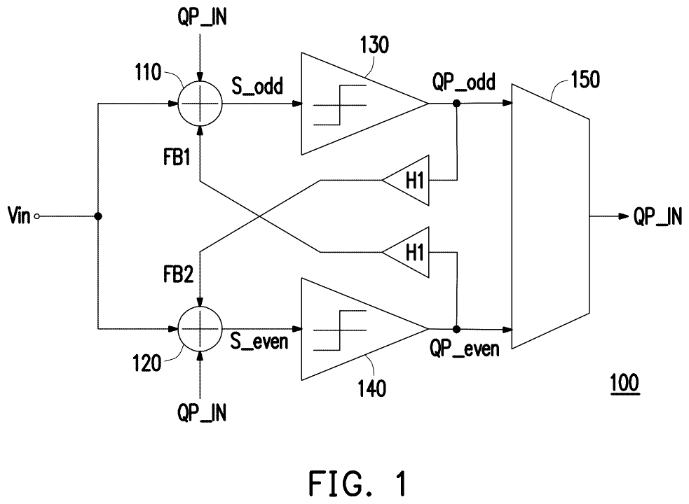

FIG. 1 is a block diagram of an equalizer circuit according to an embodiment of the disclosure. Referring to FIG. 1, the equalizer circuit 100 includes a first summing circuit 110, a second summing circuit 120, a first sampler circuit 130, a second sampler circuit 140, and a multiplexer 150. The first summing circuit 110 may generate a first summing signal S_odd based o n an input signal Vin, a first feedback signal FB1, and a polarity indication signal QP_IN. The second summing circuit 120 may generate a second summing signal S_even based on the input signal Vin, a second feedback signal FB2, and the polarity indication signal QP_IN.

Referring to FIG. 1, the first sampler circuit 130 is coupled between an output terminal of the first summing circuit 110 and an input terminal of the second summing circuit 120. The second sampler circuit 140 is coupled between an output terminal of the second summing circuit 120 and an input terminal of the first summing circuit 110. Under the above circuit connection, the equalizer circuit 100 in FIG. 1 may be realized as a half-rate decision feedback equalizer (DFE). The first sampler circuit 130 may generate a first sampled signal QP_odd based on the first summing signal S_odd. The first sampled signal QP_odd may be weighted to generate the second feedback signal FB2. The second sampler circuit 140 may generate a second sampled signal QP_even based on the second summing signal S_even. The second sampled signal QP_even may be weighted to generate the first feedback signal FB1.

According to design requirement, the weight value H1 shown in FIG. 1 may be generated by a weight circuit, such as a filter circuit. In the equalizer circuit 100 of FIG. 1, the previously decided bits in the odd channel and in the even channel are fed back with the weight value H1 and added to the received input signal Vin by using the first summing circuit 110 and the second summing circuit 120. When a magnitude and a polarity of the weight value H1 are properly adjusted to match the data channel characteristics, the inter-symbol interference (ISI) from the previous hits in the data channel can be cancelled.

In order to perform a calibration operation on the equalizer circuit 100, the multiplexer 150 is used in FIG. 1 to connect both an output terminal of the first sampler circuit 130 and an output terminal of the second sampler circuit 140. The multiplexer 150 may generate a polarity indication signal QP_IN based on one of the first sampled signal QP_odd and the second sampled signal QP_even. The equalizer circuit 100 may use the polarity indication signal QP_IN to indicate a polarity of a weight value H1 used for generating the first feedback signal FB1. In addition, the equalizer circuit 100 may also use the polarity indication signal QP_IN to indicate a polarity of a weight value H1 used for generating the second feedback signal FB2. The equalizer circuit 100 may perform calibration operation to compensate for an offset voltage of the equalizer circuit 100.

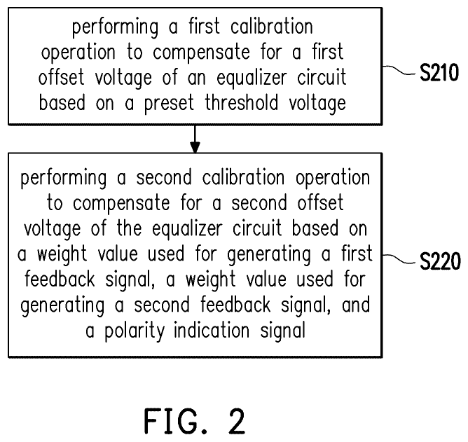

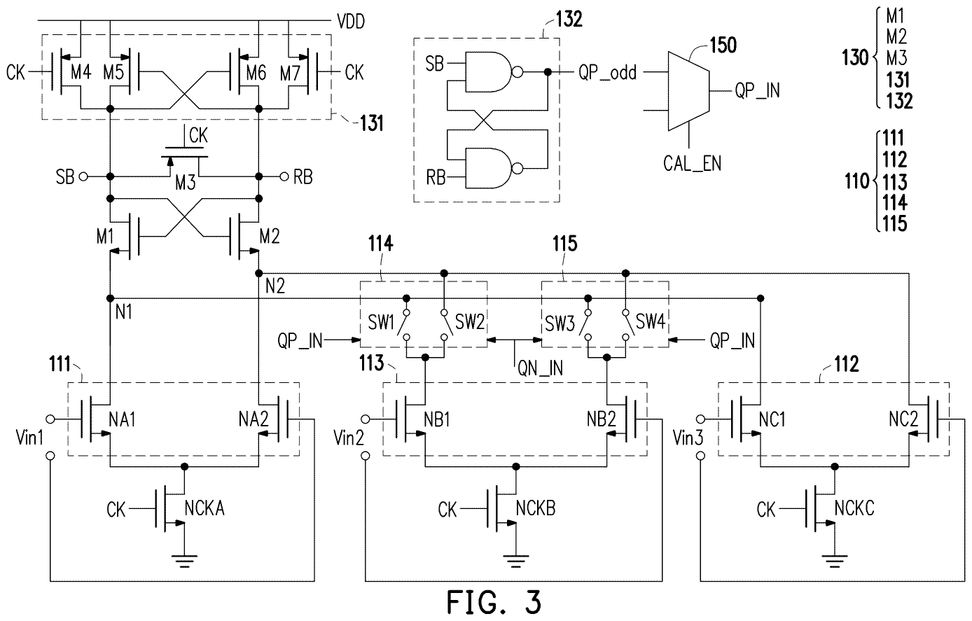

For example, FIG. 2 is a flowchart of a calibration method according to an embodiment of the disclosure. Referring to FIG. 1 and FIG. 2, in step S210, the equalizer circuit 100 may perform a first calibration operation to compensate for a first offset voltage of the equalizer circuit 100 based on a preset threshold voltage. The detailed operation of the first calibration operation may be demonstrated by using the circuit shown in FIG. 3. In the embodiment of FIG. 3, a detailed circuit for a combined architecture of the first summing circuit 110 and the first sampler circuit 1 30 shown in FIG. 1 is demonstrated. Referring to FIG. 1 and FIG. 3, the first summing circuit 110 may include a first differential amplifier 111, a second differential amplifier 112, a third differential amplifier 113, a first switch circuit 114, a second switch circuit 115, and transistors NCKA, NCKB, NCKC.

In FIG. 3, the transistor NCKA is coupled between the first differential amplifier 111 and a ground level, and a control terminal of the transistor NCKA is coupled to a clock signal CK. The first differential amplifier 111 may include differential transistors NA1 and NA2. Input terminals of the differential transistors NA1 and NA2 are coupled to an input signal Vin1, which is a differential pair signal. An output terminal of the differential transistor NA1 is coupled to a first node N1, and an output terminal of the differential transistor NA2 is coupled to a second node N2. The transistor NCKC is coupled between the second differential amplifier 112 and a ground level, and a control terminal of the transistor NCKC is coupled to a clock signal CK. The second differential amplifier 112 may include differential transistors NC1 and NC2. Input terminals of the differential transistors NC1 and NC2 are coupled to an input signal Vin3, which is a differential pair signal. An output terminal of the differential transistor NC1 is coupled to the first node N1, and an output terminal of the differential transistor NC2 is coupled to the second node N2.

The transistor NCKB is coupled between the third differential amplifier 113 and a ground level, and a control terminal of the transistor NCKB is coupled to a clock signal CK. The third differential amplifier 113 may include differential transistors NB1 and NB2. Input terminals of the differential transistors NB1 and NB2 are coupled to an input signal Vin2, which is a differential pair signal. The first switch circuit 114 may include a first switch SW1 and a second switch SW2. The first switch SW1 is coupled between the first node N1 and an output terminal of the differential transistor NB1, and the second switch SW2 is coupled between the second node N2 and the output terminal of the differential transistor NB1. The second switch circuit 115 may include a third switch SW3 and a fourth switch SW4. The third switch SW3 is coupled between the first node N1 and an output terminal of the differential transistor NB2, and the fourth switch SW4 is coupled between the second node N2 and the output terminal of the differential transistor NB2.

Referring to FIG. 1 and FIG. 3, the first sampler circuit 130 may include a first transistor M1, a second transistor M2, a third transistor M3, a precharge circuit 131, and a latch circuit 132. A control terminal of the first transistor M1 is coupled to a reset signal RB, a first terminal of the first transistor M1 is coupled to the first node N1, and a second terminal of the first transistor M1 is coupled to a set signal SB. A control terminal of the second transistor M2 is coupled to the second terminal of the first transistor M1, a first terminal of the second transistor M2 is coupled to the second node N2, and a second terminal of the second transistor M2 is coupled to the control terminal of the first transistor M1. A control terminal of the third transistor M3 is coupled to a clock signal CK, a first terminal of the third transistor M3 is coupled to the set signal SB, and the second terminal of the third transistor M3 is coupled to the reset signal RB.

The precharge circuit 131 is coupled to the second terminal of the first transistor M1 and the second terminal of the second transistor M2. According to design requirements, the precharge circuit 131 in FIG. 3 may include a fourth transistor M4, a fifth transistor M5, a sixth transistor M6, and a seventh transistor M7. A control terminal of the fourth transistor M4 is coupled to a clock signal CK, a first terminal of the fourth transistor M4 is coupled to a power voltage VDD, and the second terminal of the fourth transistor M4 is coupled to the set signal SB. A control terminal of the fifth transistor M5 is coupled to the reset signal RB, a first terminal of the fifth transistor M5 is coupled to the power voltage VDD, and the second terminal of the fifth transistor M5 is coupled to the second terminal of the fourth transistor M4. A control terminal of the sixth transistor M6 is coupled to the second terminal of the fifth transistor M5, a first terminal of the sixth transistor M6 is coupled to the power voltage VDD, and the second terminal of the sixth transistor M6 is coupled to the control terminal of the fifth transistor M5. A control terminal of the seventh transistor M7 is coupled to a clock signal CK, a first terminal of the seventh transistor M7 is coupled to the power voltage VDD, and the second terminal of the seventh transistor M7 is coupled to the second terminal of the sixth transistor M6.

A first input terminal of the latch circuit 132 is coupled to the second terminal of the first transistor M1 to receive the set signal SB. In addition, a second input terminal of the latch circuit 132 is coupled to the second terminal of the second transistor M2 to receive the reset signal RB. The latch circuit 132 may generate the first sampled signal QP_odd based on the set signal SB and the reset signal RB. The multiplexer 150 may select the first sampled signal QP_odd to generate a polarity indication signal QP_IN. In FIG. 3, since each differential pair of the differential amplifiers 111, 112, 113 may have an offset and a gain mismatch relative to other sense amplifiers in the equalizer circuit 100, a calibration operation for cancelling the offset and the gain mismatch factor is required.

Referring to FIG. 1 and FIG. 3, the equalizer circuit 100 may perform a first calibration operation to compensate for a first offset voltage VOS1 of the second differential amplifier 112 based on a preset threshold voltage. The preset threshold voltage may be a threshold voltage Vth of the differential transistors NC1 and NC2, and the first offset voltage VOS1 is an offset voltage caused by mismatch of the differential transistors NC1 and NC2. When the equalizer circuit 100 performs the first calibration operation, the first differential amplifier 111 and the third differential amplifier 113 are controlled to be turned off. Specifically, the input terminals of the first differential amplifier 111 are coupled to a ground voltage, and the input terminals of the third differential amplifier 113 are also coupled to the ground voltage. In addition, the first switch SW1, the second switch SW2, the third switch SW3, and the fourth switch SW4 are preset as an open-circuit state when the equalizer circuit 100 performs the first calibration operation. Then, a signal including a preset threshold voltage and a first offset voltage VOS1 is applied to the input terminals of the second differential amplifier 112 to perform the first calibration operation.

After the first calibration operation is finished, the equalizer circuit 100 may further perform a second calibration operation in step S220 of FIG. 2 to compensate for a second offset voltage of the third differential amplifier 113 based on the weight value H1 used for generating a first feedback signal FB1, the weight value H1 used for generating a second feedback signal FB2, and the polarity indication signal QP_IN. When the equalizer circuit 100 performs the second calibration operation, the input terminals of the first differential amplifier 111 are coupled to a ground voltage, and the input terminals of the second differential amplifier 112 are also coupled to the ground voltage. The first switch SW1 and the fourth switch SW4 are controlled by the polarity indication signal QP_IN, and the second switch SW2 and the third switch SW3 are controlled by an inversed polarity indication signal QN_IN.

For example, when the equalizer circuit 100 performs the second calibration operation and the polarity indication signal QP_IN has a first logic level (e.g., logic 1), the first switch S1 and the fourth switch S4 are turned on by receiving the polarity indication signal QP_IN, and the second switch S2 and the third switch S3 are turned off by receiving the inversed polarity indication signal QN_IN. Then, a signal including a positive weight value +H1 and the second offset voltage VOS2 is applied to the input terminals of the third differential amplifier 113 to perform a second calibration operation at a condition of the positive weight value +H1. On the other hand, when the equalizer circuit 100 performs the second calibration operation and the polarity indication signal QP_IN has a second logic level (e.g., logic 0) which is lower than the first logic level (e.g., logic 1), the first switch SW1 and the fourth switch SW4 are turned off by receiving the polarity indication signal QP_IN, and the second switch and the third switch are turned on by receiving the inversed polarity indication signal QN_IN. Then, a signal including a negative weight value −H1 and the second offset voltage VOS2 is applied to the input terminals of the third differential amplifier 113 to perform a second calibration operation at a condition of the negative weight value −H1.

Moreover, in order to perform a gain calibration for the second differential amplifier 112, the equalizer circuit 100 may perform a third calibration operation to calibrate a first bias current applied to the second differential amplifier 112. When the equalizer circuit 100 performs the third calibration operation, the input terminals of the first differential amplifier 111 are coupled to a preset voltage. A detailed method of the third calibration operation may be deduced from the embodiment of the first calibration operation, and therefore no description will be further provided.

In order to perform a gain calibration for the third differential amplifier 113, the equalizer circuit 100 may perform a fourth calibration operation to calibrate a second bias current applied to the third differential amplifier 113. When the equalizer circuit 100 performs the third calibration operation, the input terminals of the first differential amplifier 111 are coupled to a preset voltage. A detailed method of the third calibration operation may be deduced from the embodiment of the second calibration operation, and therefore no description will be further provided.

Since the second summing circuit 120 and the second sampler circuit 140 shown in FIG. 1 is similar to the combined architecture of the first summing circuit 110 and the first sampler circuit 130 shown in FIG. 3, a detailed circuit structure of a combined architecture of the second summing circuit 120 and the second sampler circuit 140 may be deduced from FIG. 3, and therefore no description will be further provided. In addition, the calibration operation using a combined architecture of the second summing circuit 120 and the second sampler circuit 140 can be deduced from the embodiments of the first to the fourth calibration operations described above, and therefore no description will be further provided.

The first to the fourth calibration operations described above may be carried out as needed, e.g., at a system startup, after waking from a sleep mode, or periodically, as desired.

In summary, in the embodiments of the disclosure, the equalizer circuit uses a polarity indication signal to indicate a polarity of a weight value for each of the even channel and the odd channel. Accordingly, a calibration operation based on a weight value having positive polarity and a weight value having negative polarity can be performed using a single sampler circuit combined with a single summing circuit, which requires fewer sampler circuits and summing circuits to perform the calibration operation. In addition, the clock loading and the power consumption of the equalizer circuit can be highly decreased due to both reduced sampler circuits and reduced summing circuits in the equalizer circuit. Therefore, the equalizer circuit and the calibration method of the disclosure can realize a DFE architecture with low-power and high-speed operation.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. An equalizer circuit, comprising:
a first summing circuit, configured to generate a first summing signal based on an input signal, a first feedback signal, and a polarity indication signal, wherein the polarity indication signal indicates a polarity of a weight value used for generating the first feedback signal;
a second summing circuit, configured to generate a second summing signal based on the input signal, a second feedback signal, and the polarity indication signal, wherein the polarity indication signal indicates a polarity of a weight value used for generating the second feedback signal;
a first sampler circuit, coupled between an output terminal of the first summing circuit and an input terminal of the second summing circuit, wherein the first sampler circuit is configured to generate a first sampled signal based on the first summing signal, and the first sampled signal is weighted to generate the second feedback signal;
a second sampler circuit, coupled between an output terminal of the second summing circuit and an input terminal of the first summing circuit, wherein the second sampler circuit is configured to generate a second sampled signal based on the second summing signal, and the second sampled signal is weighted to generate the first feedback signal; and
a multiplexer, coupled to an output terminal of the first sampler circuit and an output terminal of the second sampler circuit, wherein the multiplexer is configured to generate the polarity indication signal based on one of the first sampled signal and the second sampled signal,
wherein the equalizer circuit is configured to perform a first calibration operation to compensate for a first offset voltage of the equalizer circuit based on a preset threshold voltage,
wherein the equalizer circuit is further configured to perform a second calibration operation to compensate for a second offset voltage of the equalizer circuit based on the weight value used for generating the first feedback signal, the weight value used for generating the second feedback signal, and the polarity indication signal.

2. The equalizer circuit according to claim 1, wherein the first summing circuit comprises:
a first differential amplifier, wherein input terminals of the first differential amplifier are coupled to a first input signal, and output terminals of the first differential amplifier are coupled to a first node and a second node;
a second differential amplifier, wherein input terminals of the second differential amplifier are coupled to a second input signal, and output terminals of the second differential amplifier are coupled to the first node and the second node;
a third differential amplifier, wherein input terminals of the third differential amplifier are coupled to a third input signal;
a first switch circuit, including a first switch and a second switch, wherein the first switch is coupled between the first node and a first output terminal of the third differential amplifier, and the second switch is coupled between the second node and the first output terminal of the third differential amplifier; and
a second switch circuit, including a third switch and a fourth switch, wherein the third switch is coupled between the first node and a second output terminal of the third differential amplifier, and the fourth switch is coupled between the second node and the second output terminal of the third differential amplifier.

3. The equalizer circuit according to claim 2, wherein the first sampler circuit comprises:
a first transistor, wherein a control terminal of the first transistor is coupled to a reset signal, a first terminal of the first transistor is coupled to the first node, and a second terminal of the first transistor is coupled to a set signal;
a second transistor, wherein a control terminal of the second transistor is coupled to the second terminal of the first transistor, a first terminal of the second transistor is coupled to the second node, and a second terminal of the second transistor is coupled to the control terminal of the first transistor;
a third transistor, wherein a control terminal of the third transistor is coupled to a clock signal, a first terminal of the third transistor is coupled to the set signal, and the second terminal of the third transistor is coupled to the reset signal;
a precharge circuit, couple to the second terminal of the first transistor and the second terminal of the second transistor; and
a latch circuit, couple to the second terminal of the first transistor and the second terminal of the second transistor, wherein the latch circuit is configured to generate the first sampled signal based on the set signal and the reset signal.

4. The equalizer circuit according to claim 3, wherein the precharge circuit comprises:
a fourth transistor, wherein a control terminal of the fourth transistor is coupled to the clock signal, a first terminal of the fourth transistor is coupled to a power voltage, and the second terminal of the fourth transistor is coupled to the set signal;
a fifth transistor, wherein a control terminal of the fifth transistor is coupled to the reset signal, a first terminal of the fifth transistor is coupled to the power voltage, and the second terminal of the fifth transistor is coupled to the second terminal of the fourth transistor;
a sixth transistor, wherein a control terminal of the sixth transistor is coupled to the second terminal of the fifth transistor, a first terminal of the sixth transistor is coupled to the power voltage, and the second terminal of the sixth transistor is coupled to the control terminal of the fifth transistor; and
a seventh transistor, wherein a control terminal of the seventh transistor is coupled to the clock signal, a first terminal of the seventh transistor is coupled to the power voltage, and the second terminal of the seventh transistor is coupled to the second terminal of the sixth transistor.

5. The equalizer circuit according to claim 2, wherein when the equalizer circuit performs the first calibration operation,
the first switch, the second switch, the third switch, and the fourth switch are turned off; and
the input terminals of the second differential amplifier are coupled to a signal including the preset threshold voltage and the first offset voltage.

6. The equalizer circuit according to claim 2,
wherein when the equalizer circuit performs the second calibration operation and the polarity indication signal has a first logic level,
the first switch and the fourth switch are turned on;
the second switch and the third switch are turned off; and
the input terminals of the third differential amplifier are coupled to a signal including the second offset voltage and the weight value having a positive polarity;
wherein when the equalizer circuit performs the second calibration operation and the polarity indication signal has a second logic level which is lower than the first logic level,
the first switch and the fourth switch are turned off;
the second switch and the third switch are turned on; and
the input terminals of the third differential amplifier are coupled to a signal including the second offset voltage and the weight value having a negative polarity.

7. The equalizer circuit according to claim 2, wherein when the equalizer circuit performs any one of the first calibration operation and the second calibration operation, the input terminals of the first differential amplifier are coupled to a ground voltage.

8. The equalizer circuit according to claim 2, wherein the equalizer circuit is further configured to perform a third calibration operation to calibrate a first bias current applied to the second differential amplifier,
wherein the equalizer circuit is further configured to perform a fourth calibration operation to calibrate a second bias current applied to the third differential amplifier.

9. The equalizer circuit according to claim 8, wherein when the equalizer circuit performs any one of the third calibration operation and the fourth calibration operation, the input terminals of the first differential amplifier are coupled to a preset voltage.

10. A calibration method for an equalizer circuit, wherein the equalizer circuit comprises:
a first sampler circuit, configured to generate a first sampled signal, and the first sampled signal is weighted to generate the second feedback signal;
a second sampler circuit, configured to generate a second sampled signal, and the second sampled signal is weighted to generate the first feedback signal
a multiplexer, coupled to an output terminal of the first sampler circuit and an output terminal of the second sampler circuit, wherein the multiplexer is configured to generate a polarity indication signal based on one of the first sampled signal and the second sampled signal, wherein the polarity indication signal indicates a polarity of a weight value used for generating the first feedback signal and a polarity of a weight value used for generating the second feedback signal,
wherein the calibration method for the equalizer circuit comprises:
performing a first calibration operation to compensate for a first offset voltage of the equalizer circuit based on a preset threshold voltage; and
performing a second calibration operation to compensate for a second offset voltage of the equalizer circuit based on the weight value used for generating the first feedback signal, the weight value used for generating the second feedback signal, and the polarity indication signal.

11. The calibration method according to claim 10, wherein the equalizer circuit further comprises:
a first differential amplifier, wherein input terminals of the first differential amplifier are coupled to a first input signal, and output terminals of the first differential amplifier are coupled to a first node and a second node;
a second differential amplifier, wherein input terminals of the second differential amplifier are coupled to a second input signal, and output terminals of the second differential amplifier are coupled to the first node and the second node;
a third differential amplifier, wherein input terminals of the third differential amplifier are coupled to a third input signal;
a first switch circuit, including a first switch and a second switch, wherein the first switch is coupled between the first node and a first output terminal of the third differential amplifier, and the second switch is coupled between the second node and the first output terminal of the third differential amplifier; and
a second switch circuit, including a third switch and a fourth switch, wherein the third switch is coupled between the first node and a second output terminal of the third differential amplifier, and the fourth switch is coupled between the second node and the second output terminal of the third differential amplifier.

12. The calibration method according to claim 11, wherein when performing the first calibration operation,
turning off the first switch, the second switch, the third switch, and the fourth switch; and
providing a signal including the preset threshold voltage and the first offset voltage to the input terminals of the second differential amplifier.

13. The calibration method according to claim 11, wherein
when performing the second calibration operation and the polarity indication signal has a first logic level,
turning on the first switch and the fourth switch;
turning off the second switch and the third switch; and
providing a signal including the second offset voltage and the weight value having a positive polarity to the input terminals of the third differential amplifier;
when performing the second calibration operation and the polarity indication signal has a second logic level which is lower than the first logic level,
turning off the first switch and the fourth switch;
turning on the second switch and the third switch; and
providing a signal including the second offset voltage and the weight value having a negative polarity to the input terminals of the third differential amplifier.

14. The calibration method according to claim 11, wherein when the equalizer circuit performs any one of the first calibration operation and the second calibration operation,
providing a ground voltage to the input terminals of the first differential amplifier.

15. The calibration method according to claim 11, further comprising:
performing a third calibration operation to calibrate a first bias current applied to the second differential amplifier; and
performing a fourth calibration operation to calibrate a second bias current applied to the third differential amplifier.

16. The calibration method according to claim 11, wherein when performing any one of the third calibration operation and the fourth calibration operation,
providing a preset voltage to the input terminals of the first differential amplifier.
